(19) United States
(12) Patent Application Publication
(10) Pub. No.: US 2009/0058789 A1
(43) Pub. Date: Mar. 5, 2009

(54) Digital play system, LCD display module and display control method

(75) Inventors: Chih-Ming Hung, Taipei County (TW); Tsu-Huai Chan, Taipei County (TW)

Correspondence Address: BACON & THOMAS, PLLC, 625 SLATERS LANE, FOURTH FLOOR, ALEXANDRIA, VA, 22314-1176, US

(73) Assignee: Jinq Kaih Technology Co., Ltd., Taipei County (TW)

(21) Appl. No.: 12/230,271

(22) Filed: Aug. 27, 2008

(30) Foreign Application Priority Data
Aug. 27, 2007 (TW) 96131708

(51) Int. Cl. G09G 3/36

(52) U.S. Cl. 345/100

(57) ABSTRACT

The present invention provides a digital play system, comprising a signal conversion unit to receive a video signal and convert it into image data; and a LCD display module consisting of a timing controller to receive said image data and output row control signals and pixel data, a row driver to receive row control signals and output row driving signals, and a display panel to receive the row driving signals and pixel data, wherein the timing controller controls the row driver to output odd row driving signals and even row driving signals to display alternately odd-row array and even-row array of the display panel.

The present invention provides a digital play system, comprising a signal conversion unit to receive a video signal and convert it into image data; and a LCD display module consisting of a timing controller to receive said image data and output row control signals and pixel data, a row driver to receive row control signals and output row driving signals, and a display panel to receive the row driving signals and pixel data, wherein the timing controller controls the row driver to output odd row driving signals and even row driving signals to display alternately odd-row array and even-row array of the display panel.

### BACKGROUND OF THE INVENTION

1. Field of the Invention

The present invention discloses a digital play system and display control method, particularly a kind of LCD display module and display control method used in LCD display and a digital play system comprising said LCD display module and using said display control method.

2. Description of Related Art

FIG. 9 shows the circuit diagram of a digital television play system according to prior art. The conventional digital television play system comprises a TV modulator 1 and a TV demodulator 2. The TV modulator 1 receives TV signals from antenna, which are converted into video signals through demodulator 2. A signal conversion unit 3 containing MPEG II decoder chip receives the video signals generated by demodulator 2 and converts the signals into image data. Based on prior art, the image data has resolution of 720×480.

To display the TV signals on the LCD panel of a LCD module 6, the signal conversion unit 3 outputs the image data to a deinterlace processor 4 to undergo deinterlace operations. The resolution of image data is usually different from that of the LCD panel, for example, high-resolution LCD panel is 800×480. Thus a deinterlace processor 4 would output image data to a scaling unit 5 to undergo row upsampling to bring the resolution of image data in line with that of the LCD panel. After upsampling, the scaling unit 5 would output the image data to the LCD module 6 for display on the LCD panel.

FIG. 10 shows the circuit diagram of a LCD module according to prior art. The LCD module 6 contains a timing controller 7, a row-driver 8, a column-driver 9 and a LCD panel 14. The timing controller 7 receives deinterlaced and up-sampled image data and generates row control signals and column control signals for output to the row-driver 8 and the column-driver 9 respectively. The row-driver 8 and the column-driver 9 output respectively row driving signals and column driving signals to LCD panel 14 to drive said LCD panel 14 display of image data.

FIG. 11 shows the timing diagram of signals output by timing controller according to prior art. The signals output by timing controller 7 include image data signal, row control signals and column control signals. The column control signals comprise start signal (STV), reverse signal (REV) and load signal (TP), whereas the row control signals include start signal (STV), row clock signal (CPV) and output enable signal (OE). Row-driver 8 generates a plurality of row driving signals based on the row control signals, whereas column-driver 9 generates a plurality of column driving signals based on the column control signals.

FIG. 12 shows the timing of row output enabling control according to prior art. In prior art, in each cycle of row start signal (STV), all row driving signals 1-n are generated in sequence, and respective row driving signal 1-n corresponds in sequence to the clock pulse signal (CPN) and output enable signal (OE) generated in each cycle timing. In other words, in each cycle of row start signal (STV), clock pulse signal (CPV) and OE have the same frequency and each cycle generates in sequence row driving signals 1-n. In one cycle of CPV, when OE is L (low-level), the corresponding row driving signal will be H (high level).

In one cycle of STV, the first cycle of CPV and the first cycle of OE determine the timing of row driving signals 1 being H; the second cycle of CPV and the second cycle of OE determine the timing of column driving signals 2 being H; and so on. Thus in one cycle of STV, each row driving signal 1-n represents only one pulse activity. Different from prior art, the frequency of STV and each row driving signal could be 60 Hz or 50 Hz.

FIG. 13 shows a pixel reversal diagram of LCD panel according to prior art. Because each pixel corresponds to the a liquid crystal display unit of LCD panel 14 and the liquid crystal display unit has capacitance effect (including a hold capacitance C_{ST} and liquid crystal capacitance C_{LC}), if the voltage added to two ends of the capacitor is not reversed, the displayed pixel will be charged under the same voltage for a long period of time. The prolonged storage of electric charges between the electrodes would in serious cases cause the liquid crystal to polarize and render the pixel display ineffectual, and in mild cases, cause background color to appear and decrease color contrast in the display of LCD panel 14. Such phenomenon is more serious in high-resolution LCD panel 14. Hence the voltage signal for driving the pixels must be reversed every other STV cycle to neutralize the electric charges stored under capacitance effect.

### SUMMARY OF THE INVENTION

According to prior art, the digital television play system must subject the image data of TV signals to deinterlace operation before displaying the images on the LCD panel. The work requires the use of deinterlace processor chip, thereby adding to the system cost. Or the playing system could realize the deinterlace operation through signal conversion unit or the timing controller of the LCD module, which however adds to the complexity of system design.

The object of the present invention is to provide a digital play system, which displays the image data of a picture on LCD panel in alternate sequence of odd-row array and even-row array without requiring the execution of interlace operation.

Another object of the present invention is to provide a LCD display module. The timing controller of the LCD display module outputs odd/even row driving signals in sequence to display the image data of a picture on LCD panel in alternate sequence of odd-row array and even-row array.

Yet another object of the present invention is to provide a display control method where the image data of a picture are displayed on LCD panel in alternate sequence of odd-row array and even-row array.

In one embodiment to achieve the aforesaid objects, the digital play system according to the present invention comprises a signal conversion unit for receiving a video signal and converting it into image data; and a LCD display module consisting of a timing controller for receiving the image data and outputting row control signals and pixel data; a row driver for receiving the row controller signals and outputting row driving signals; and a display panel for receiving the row driving signals and pixel data, wherein the timing controller controls the output of odd-row driving signals and even-row driving signals by the row driver to alternate the odd-row array and even-row array of the display panel for the display of pixel data.

In another embodiment of the present invention, the LCD display module comprises a timing controller for receiving image data and outputting row control signals, column control signals and pixel data; a row driver for receiving the row control signals and outputting row driving signals; and a column driver for receiving the column control signals and outputting column driving signals; and a display panel for receiving the row driving signals, column driving signals and pixel data, wherein the timing controller controls the timing of row driving signals to alternate the odd-row array and even-row array of the display panel for the display of pixel data.

In yet another embodiment of the present invention, the display control method displays image data on a display panel, comprising the steps of: converting the image data into pixel data; outputting odd-row driving signals; outputting even-row driving signals; and based on the odd-row driving signals and even-row driving signals, alternating the odd-row array and even-row array of the display panel for the display of pixel data.

The objects, features and effects of the present invention are described in detail below with embodiments in reference to the accompanying drawings, which however are not meant to limit or confine the actual applications of the invention.

### BRIEF DESCRIPTION OF THE DRAWINGS

FIG. 1 is the circuit diagram of a LCD display system according to the present invention.

FIG. 2 is a diagram of odd-row/even-row pixel arrays of image data displayed on the LCD panel according to the present invention.

FIG. 3 is the circuit diagram of a LCD display module according to the present invention.

FIG. 4 is the control timing diagram of the odd-row driving signals according to a first embodiment of the present invention.

FIG. 5 is the control timing diagram of the even-row driving signals according to a first embodiment of the present invention.

FIG. 6 is the control timing diagram of the odd-row driving signals according to a second embodiment of the present invention.

FIG. 7 is the control timing diagram of the even-row driving signals according to a second embodiment of the present invention.

FIG. 8A and FIG. 8B show the pixel reversal diagram of the LCD panel according to the present invention.

FIG. 9 shows the circuit diagram of a digital television play system according to prior art.

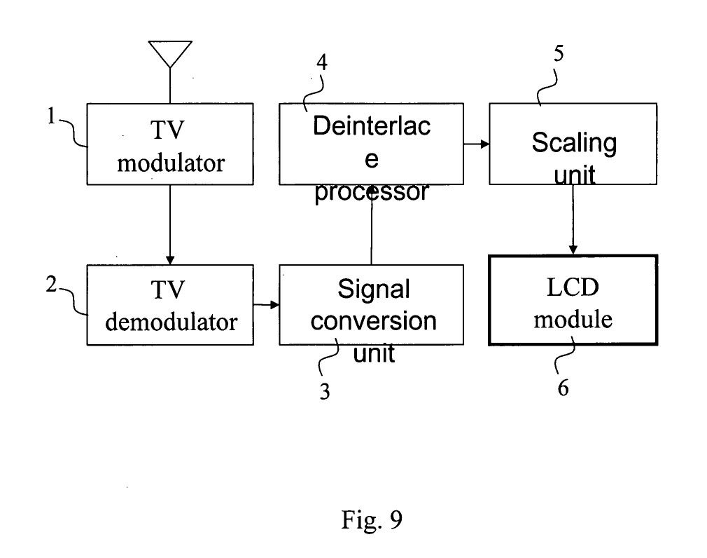

FIG. 10 shows the circuit diagram of a LCD module according to prior art.

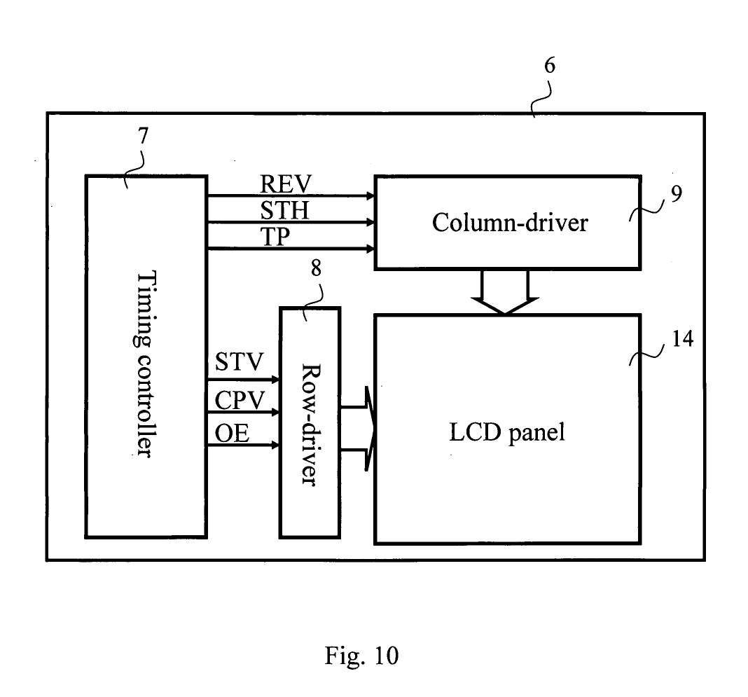

FIG. 11 shows the timing diagram of signals output by timing controller according to prior art.

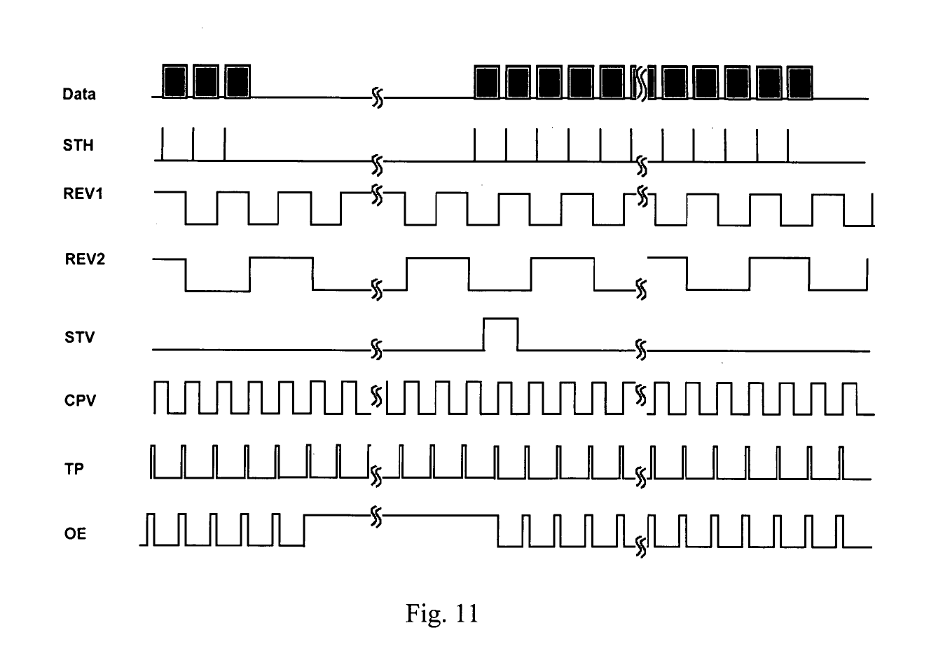

FIG. 12 shows the timing of row output enabling control according to prior art.

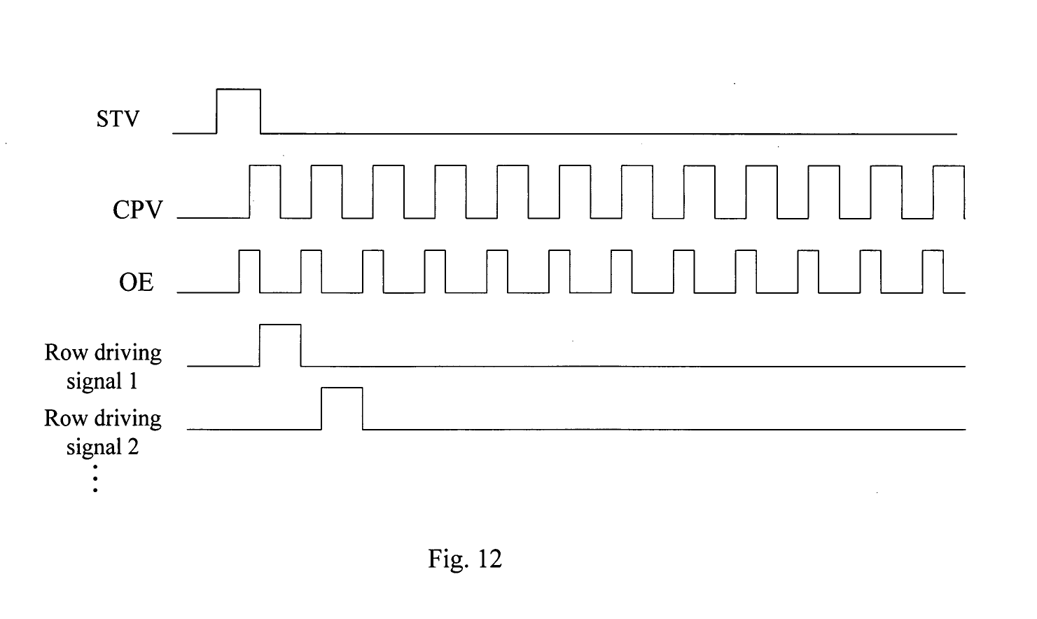

FIG. 13 shows a pixel reversal diagram of LCD panel according to prior art.

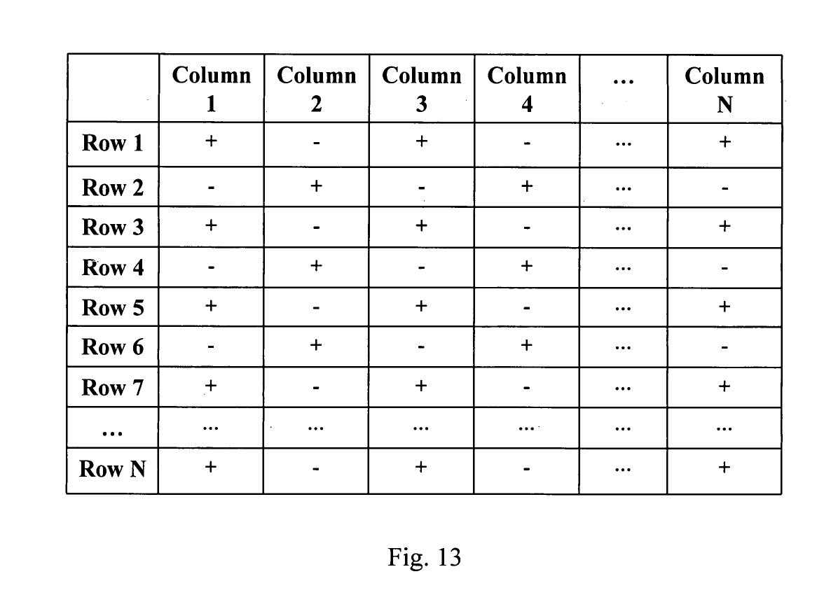

### DETAILED DESCRIPTION OF THE INVENTION

The present invention will be fully described with preferred embodiments and accompanying drawings. It should be understood beforehand that any person familiar with the skill is able to make modification to the invention described and attain the same effect, and that the description below is a general representation to people familiar with the skill and should not be construed as a limitation on the actual applicable scope of the present invention.

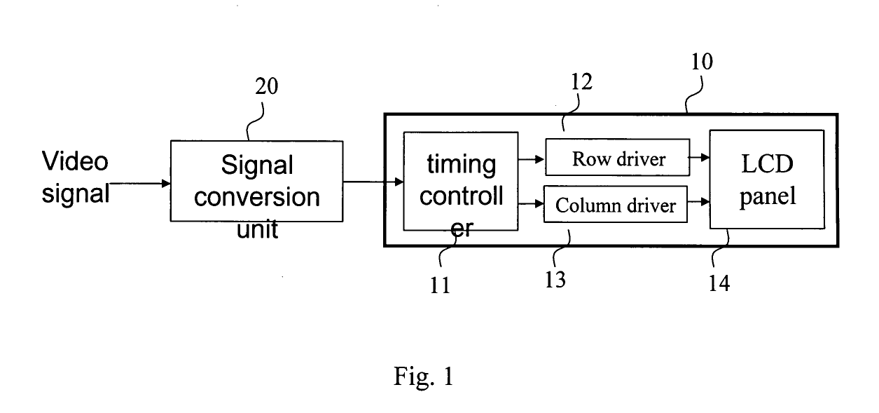

FIG. 1 shows the circuit diagram of a digital play system according to the present invention. In a preferred embodiment of the present invention, the digital play system comprises a signal conversion unit 20 and a LCD display module 10. The signal conversion unit 20 converts a video signal into image data and outputs the image data to the LCD display module 10. In an embodiment of the invention, the video signal is TV signal, and the image data are alternately scanned picture data.

The LCD display module 10 comprises a timing controller 11, a row driver 12, a column driver 13 and a LCD panel 14. The connections between the components are as shown in FIG. 1. The timing controller 11 receives the image data and outputs row control signals, column control signals and pixel data. The row driver 12 receives row control signals and outputs row driving signals to the LCD panel 14. The column driver 13 receives column control signals and outputs column driving signals to the LCD panel 14. The LCD panel 14 displays pixel data according to the row driving signals and column driving signals.

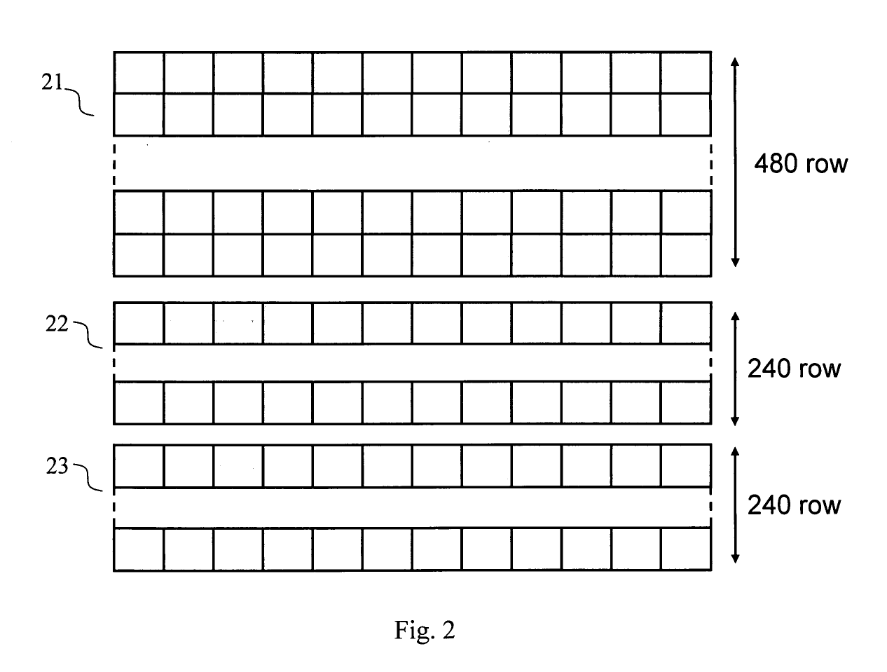

FIG. 2 is a diagram of odd-row/even-row pixel arrays of image data displayed on the LCD panel according to the present invention. In an embodiment of the invention, the image data represent an alternately scanned picture 21, ex. a NTSC picture with 720×480 resolution. The image data contain odd-row pixel array 22 and even-row pixel array 23, the resolutions of odd-row pixel array 22 and even-row pixel array 23 being 720×240.

In a preferred embodiment of the present invention, the signal conversion unit 20 outputs the alternately scanned picture data to the timing controller 11 of LCD display module 10. The timing controller 11 does not subject the picture data to deinterlace operation, but directly display the odd-row pixel array 22 of the picture data at the odd-numbered rows of LCD panel 14 and then display the even-row pixel array 23 at the even-numbered rows of LCD panel 14. Because the liquid crystal display unit of LCD panel 14 has capacitance effect (including a hold capacitance C_{ST} and liquid crystal capacitance C_{LC}), each liquid crystal display unit could store the corresponding pixel data. When the odd-row array and the even-row array of LCD panel 14 alternately display the pixel data of a picture, the odd-row and even-row liquid crystal display units store the pixel data to keep the display of pictures continuous.

In an embodiment of the invention, the LCD panel 14 has a resolution of 800×480. For the LCD panel 14 to display alternately the odd-row pixel array 22 and even-row pixel array 23 of the image data, the timing controller 11 undergoes row upsampling to turn the resolution of odd-row pixel array 22 and even-row pixel array 23 to 800×240. The timing controller 11 also outputs row control signals to control the generation of respectively odd-row driving signals and even-row driving signals by the row driver 12. The LCD panel 14 alternately displays the odd-row pixel array 22 and the even-row pixel array 23 of image data based on the odd-row driving signals and the even-row driving signals.

In a preferred embodiment, the display control method of the present invention displays image data on a display panel, comprising the steps of: converting the image data into pixel data; timing controller 11 controlling the timing of odd-row driving signals; timing controller 11 controlling the timing of even-row driving signals; and based on the odd-row driving signals and even-row driving signals, alternating the odd-row array and even-row array of the display panel for the display of pixel data.

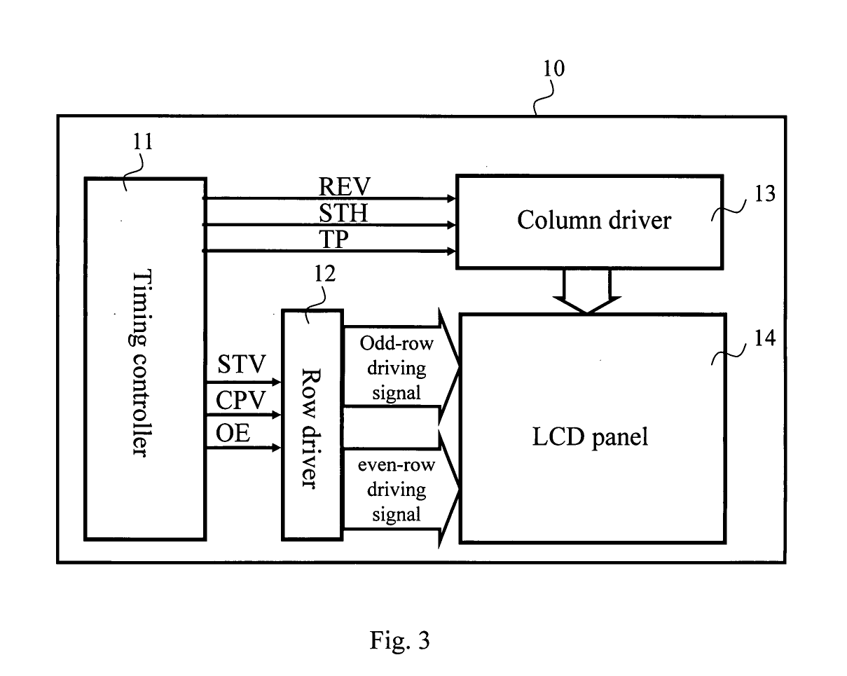

FIG. 3 is the circuit diagram of a LCD display module according to the present invention. In this embodiment, the row control signals output by timing controller 10 to the row driver 12 include start signal (STV), row clock signal (CPU) and output enable signal (OE), wherein in one cycle of STV, the row driver 12 outputs odd-row driving signals 1, 3, 5 . . . and even-row driving signals 2, 4, 6 . . . such that the STV could be enabled in different cycles. Furthermore, in the STV cycle, the timing controller 10 alternately enables the timing of the odd-row driving signals 1, 3, 5 . . . and even-row driving signals 2, 4, 6 . . . based on the CPV and OE.

The digital play system according to the present invention first displays the image data of a picture at odd-numbered rows of the LCD panel with odd-row driving signals and then display the image data at even-numbered rows of the LCD panel with even-row driving signals. Thus in one cycle of STV, timing controller 11 can only control the row driver 12 to drive the odd rows or even rows of the LCD panel. In other words, it takes two cycles of STV to complete the display of image data of one picture.

According to an embodiment of the invention as shown in FIG. 3, the LCD display module implements a display control method to display image data on a display panel 14, comprising the steps of: timing controller 11 converting the image data into pixel data; timing controller 11 controlling the row driver 12 to output odd-row driving signals; timing controller 11 controlling the row driver 12 to output even-row driving signals; timing controller 11 alternately enabling the timing of odd-row driving signals and even-row driving signals; and the display panel 14 alternately displaying the pixel data at odd-row array and even-row array of the display panel based on the timing of odd-row driving signals and even-row driving signals.

The display control method of the invention further comprises the steps of: timing controller 11 providing the row start signal (STV) with preset frequency; and in one cycle of the STV, timing controller 11 controlling the row driver 12 to enable the timing of odd-row driving signals and disable the timing of even-row driving signals, or the timing controller 11 controlling the row driver 12 to enable the timing of even-row driving signals and disable the timing of odd-row driving signals. The control timing of the odd/even driving signals in the first and the second embodiments of the invention are described further below.

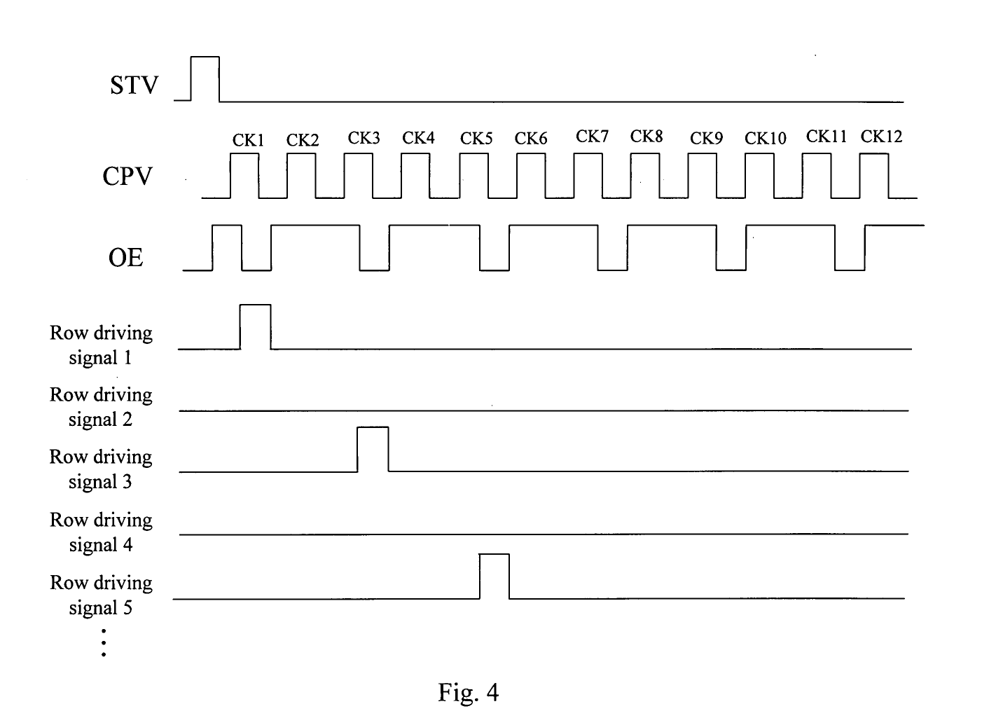

FIG. 4 shows the control timing diagram of the odd-row driving signals according to a first embodiment of the invention. When the timing controller 11 controls the row driver 12 to output odd-row driving signals 1, 3, 5 . . . in one cycle of STV, the timing of even-row driving signals 2, 4, 6 . . . is disabled in this cycle of STV. Only when the output enable signal (OE) is L (low level) would the timing of row driving signals be enabled. Thus to disable the timing of even-row driving signals 2, 4, 6 . . . , the OE corresponding to the even-numbered cycles of row clock signal (CPV) CK2, CK4, . . . in this cycle of STV are kept at H (high level). In this cycle of STV, OE corresponding to the odd-numbered cycles of row clock signal (CPV) CK1, CK3 . . . could enable the timing of odd-row driving signals 1, 3, 5 . . . . As shown in FIG. 4, when the odd-number cycles CK1, CK3 . . . of row clock signal (CPV) corresponding to the OE is L (low level), it could enable the timing of odd-row driving signals 1, 3. 5 . . . .

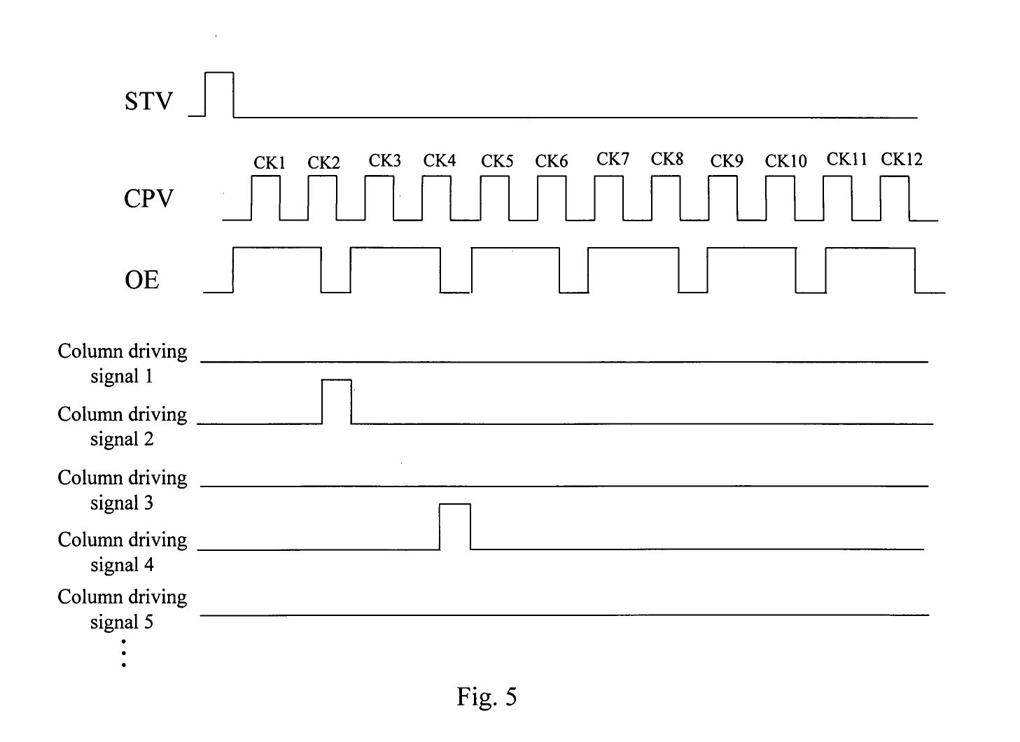

FIG. 5 is the control timing diagram of the even-row driving signals according to a first embodiment of the invention. diagram of the odd-row driving signals according to a first embodiment of the invention. When the timing controller 11 controls the row driver 12 to output even-row driving signals 2, 4, 6 . . . in one cycle of STV, the odd-row driving signals 1, 3, 5 . . . are disabled in this cycle of STV. Only when the output enable signal (OE) is at L (low level) would the timing of row driving signals be enabled. Thus to disable the timing of odd-row driving signals 1, 3, 5 . . . , the OE corresponding to the odd-numbered cycles of row clock signal (CPV) CK1, CK3, . . . in this cycle of STV are kept at H (high level). In this cycle of STV, OE corresponding to the even-numbered cycles of row clock signal (CPV) CK2, CK4 . . . could enable the timing of even-row driving signals 2, 4, 6 . . . . As shown in FIG. 5, when the odd-number cycles CK2, CK4 . . . of row clock signal (CPV) corresponding to the OE is L (low level), the timing of odd-row driving signals 2, 4, 6 . . . is enabled.

According to the digital play system and the LCD display module in the first embodiment of the present invention, the timing controller 11 outputs the row control signals including STV, CPV and OE, where in the sequential cycle of STV, the timing controller 11 alternately enables the odd-row driving signals 1, 3, 5 . . . and the even-row driving signals 2, 4, 6 . . . , and the frequency of CPV is twice the frequency of OE.

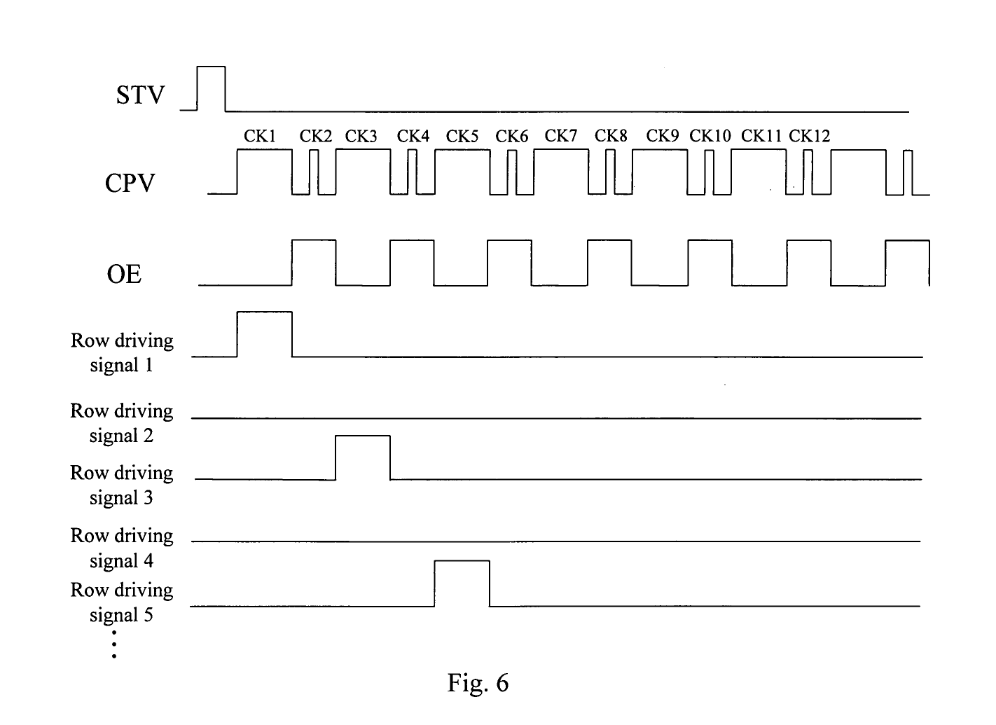

FIG. 6 is the control timing diagram of the odd-row driving signals according to a second embodiment of the present invention. When the timing controller 11 controls the row driver 12 to output odd-row driving signals 1, 3, 5 . . . in one cycle of STV, the timing of even-row driving signals 2, 4, 6 . . . are disabled in this cycle of STV. Because the enabling of row driving signal timing is determined by OE and CPV, to disable the timing of even-row driving signals 2, 4, 6 . . . , the even-numbered cycles of row clock signal (CPV) CK2, CK4 . . . corresponding to output enable signal (OE) are H (high level) in this cycle of STV so as to disable the timing of even-row driving signals 2, 4, 6 . . . . In this cycle of STV, when the odd-numbered cycles of row clock signal (CPV) CK1, CK3 . . . corresponding to OE is L (low level), the timing of odd-row driving signals 1, 3, 5 . . . is enabled. As shown in FIG. 6, when the odd-number cycles CK1, CK3 . . . of row clock signal (CPV) corresponding to the OE is L (low level), the timing of odd-row driving signals 1, 3. 5 . . . is enabled.

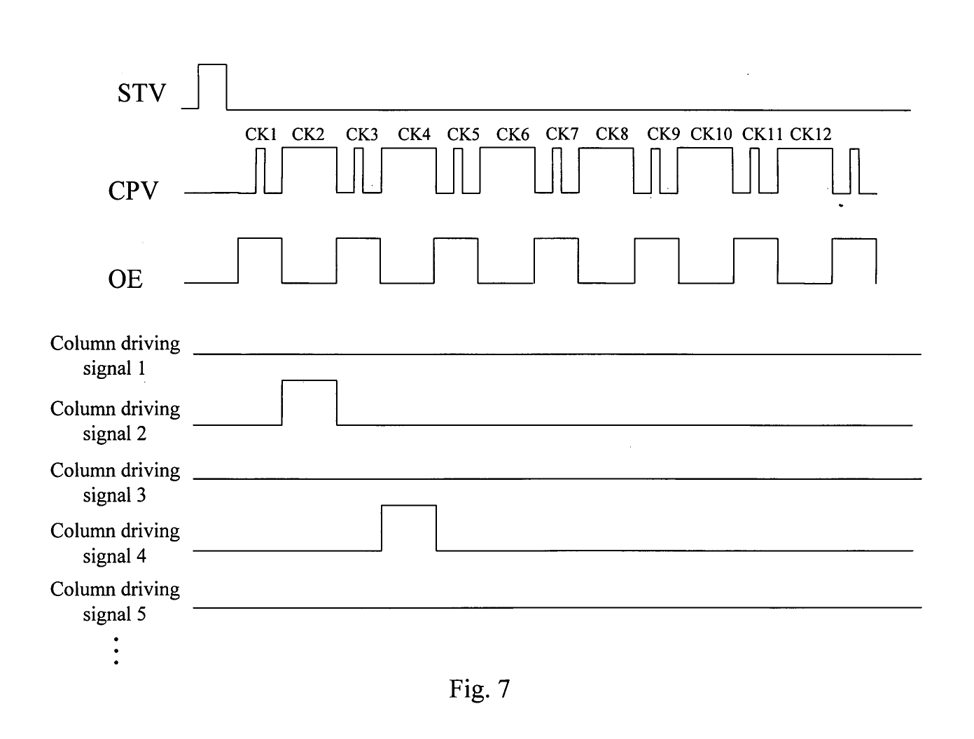

FIG. 7 is the control timing diagram of the even-row driving signals according to a second embodiment of the present invention. When the timing controller 11 controls the row driver 12 to output even-row driving signals 2, 4, 6 . . . in one cycle of STV, the timing of odd-row driving signals 1, 3, 5 . . . is disabled in this cycle of STV. Because the enabling of row driving signal timing is determined by OE and CPV, to disable the timing of odd-row driving signals 1, 3, 5 . . . , the odd-numbered cycles of row clock signal (CPV) CK1, CK3 . . . corresponding to output enable signal (OE) are H (high level) in this cycle of STV so as to disable the timing of odd-row driving signals 1, 3, 5 . . . . In this cycle of STV, when the even-numbered cycles of row clock signal (CPV) CK2, CK4 . . . corresponding to OE are L (low level), the timing of even-row driving signals 2, 4, 6 . . . are enabled. As shown in FIG. 7, the even-numbered cycles of row clock signal (CPV) CK2, CK4 . . . corresponding to OE are L (low level), the timing of even-row driving signals 2, 4, 6 . . . are enabled.

According to the digital play system and the LCD display module in the second embodiment of the present invention, the timing controller 11 outputs the row control signals including STV, CPV and OE, where in the sequential cycle of STV, the timing controller 11 alternately enables the odd-row driving signals 1, 3, 5 . . . and the even-row driving signals 2, 4, 6 . . . , and the frequency of OE is the same as that of CPV, but the one cycle of OE corresponds to two pulse signals of CPV, wherein the H (high level) pulse signal corresponding to OE would disable the timing of odd or even driving signals.

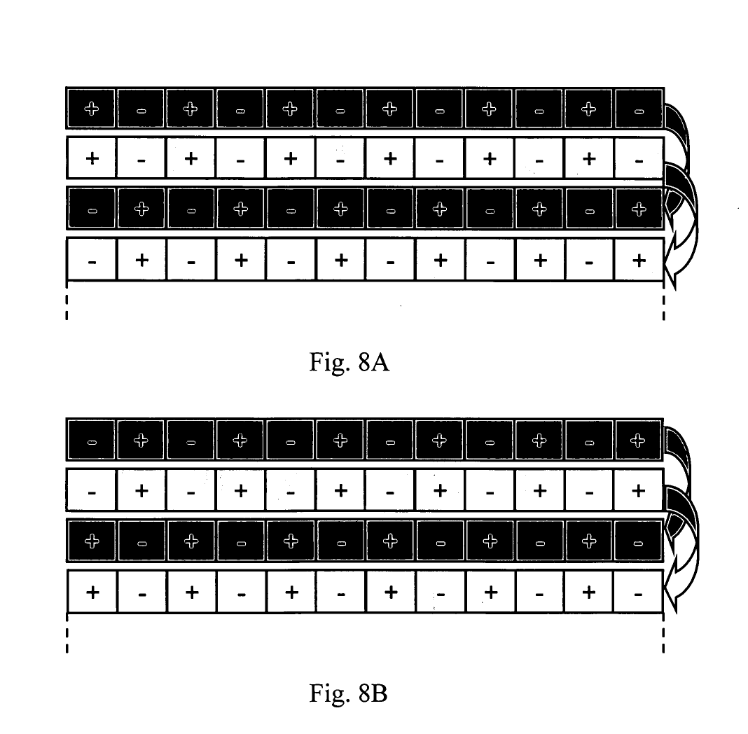

FIG. 8A and FIG. 8B show the pixel reversal diagram of the LCD panel according to the present invention. According to the digital play system and LCD display module in the first embodiment or the second embodiment of the invention, in one cycle of STV, the timing controller 11 controls the row driver 12 to drive the display of only odd-row pixel array 22 or even-row pixel array 23. The reversal signal (REV) output by the timing controller 11 to column driver 13 corresponding to one cycle of STV also reverses just the odd-row pixel array 22 or the even-row pixel array 23. In other words, it takes two STV cycles to complete the reversal of driving voltage signals of all liquid crystal display units of the LCD panel 14.

The REV as output by the timing controller is as shown in FIG. 8A where the driving voltage signals of odd/even liquid crystal display units of LCD panel 14 are reversed in every two cycles of STV; next in FIG. 8B, the driving voltage signals of odd/even liquid crystal display units of LCD panel 14 are reversed in every two cycles of STV.

In an embodiment of the present invention, when the frequency of STV is 60 Hz, the REV output by the timing controller 11 reverses the odd-row pixel array 22 and the even-row pixel array 23 once very 1/30 seconds respectively.

According to the digital play system, LCD display module and display control method of the present invention, the play system does not need to carry out deinterlace operation before the LCD panel 14 displays the image data of TV signal, which helps eliminate the cost of deinterlace processor chip and reduce the complexity of system design. Using a timing controller to control the output of odd/even driving signals by a row driver allows the LCD panel to alternately display the pixel data of a picture using odd-row array and even-row array. The present invention is suitable for application in digital TV with a small or mid-sized digital panel or other portable digital play systems to obtain better display effect than analog panel.

The preferred embodiments of the present invention have been disclosed in the examples. However the examples should not be construed as a limitation on the actual applicable scope of the present invention, and as such, all modifications and alterations without departing from the spirits of the present invention remain within the protected scope and claims of the present invention.

What is claimed is:

1. A liquid crystal display module, comprising:
a timing controller for receiving image data and outputting row control signals, column control signals and pixel data;
a row driver for receiving the row control signals and outputting row driving signals;
a column driver for receiving the column control signals and outputting column driving signals; and
a display panel for receiving the row driving signals, column driving signals and pixel data;
wherein the timing controller controls the timing of row driving signals to alternate the odd-row array and even-row array of the display panel for display of the pixel data.

2. The liquid crystal display module according to claim 1, wherein the row control signals contain a row start signal with a preset frequency, the frequency of the odd-row driving signal being half the preset frequency of the row start signal.

3. The liquid crystal display module according to claim 1, wherein the row control signals contain at least a row start signal with a preset frequency, the frequency of the even-row driving signal being half the preset frequency of the row start signal.

4. The liquid crystal display module according to claim 1, wherein the row control signals contain at least a row start signal with a preset cycle, a row clock signal and an output enable signal, the row driver outputting odd-row driving signals twice the preset cycle of the row start signal to drive the odd-row array of the display panel.

5. The liquid crystal display module according to claim 4, wherein in the preset cycle of the row start signal, the frequency of the output enable signal is half the frequency of the row clock signal.

6. The liquid crystal display module according to claim 4, wherein in the preset cycle of the row start signal, the frequency of the row clock signal is the same as that of the output enable signal, and the output enable signal in one cycle corresponds to two pulse signals of the row clock signal, wherein the high level pulse signal corresponding to the output enable signal could disable the timing of odd or even row driving signals.

7. The liquid crystal display module according to claim 1, wherein the row control signal contains at least: a row start signal with a preset cycle, a row clock signal and an output enable signal, the row driver outputting even-row driving signals twice the preset cycle of the row start signal to drive the even-row array of the display panel.

8. The liquid crystal display module according to claim 7, wherein in the preset cycle of the row start signal, the frequency of the output enable signal is half the frequency of the row clock signal.

9. The liquid crystal display module according to claim 7, wherein in the preset cycle of the row start signal, the frequency of the row clock signal is the same as that of the output enable signal, and the output enable signal in one cycle corresponds to two pulse signals of the row clock signal, wherein the high level pulse signal corresponding to the output enable signal could disable the timing of odd or even row driving signals.

10. The liquid crystal display module according to claim 1, wherein the timing controller outputs a reversal signal and a row start signal, the frequency of the reversal signal being half that of the row start signal.

11. A display control method to display image data on a display panel, comprising the steps of:
converting the image data into pixel data;
outputting odd-row driving signals;
outputting even-row driving signals; and
alternating the odd-row array and even-row array of the display panel based on the odd-row driving signals and even-row driving signals for display of the pixel data.

12. The display control method according to claim 11, further comprising the steps of: providing a row start signal with a preset cycle, a row clock signal and a row output enable signal, the odd-row driving signals having a cycle twice the preset cycle of the row start signal to drive the odd-row array of the display panel.

13. The display control method according to claim 11, further comprising the steps of: providing a row start signal with a preset cycle, a row clock signal and a row output enable signal, the even-row driving signals having a cycle twice the preset cycle of the row start signal to drive the even-row array of the display panel.

14. The display control method according to claim 11, further comprising the steps of: alternately enabling the timing of odd-row driving signals and even-row driving signals in the preset cycle of the row start signal based on the row clock signal and the output enable signal.

15. The display control method according to claim 14, wherein the frequency of the odd-row driving signals is half the preset frequency of the row start signal.

16. The display control method according to claim 14, wherein the frequency of the even-row driving signal is half the preset frequency of the row start signal.

17. The display control method according to claim 14, wherein in the preset cycle of the row start signal, the frequency of the output enable signal is half that of the row clock signal.

18. The display control method according to claim 14, wherein in the preset cycle of the row start signal, the frequency of the row clock signal is the same as that of the output enable signal, and the output enable signal in one cycle corresponds to two pulse signals of the row clock signal, wherein the high level pulse signal corresponding to the output enable signal could disable the timing of odd or even row driving signals.

19. The display control method according to claim 11, further comprising the steps of: providing a row start signal with a preset frequency; and enabling the timing of the even-row driving signals and disabling the timing of the odd-row driving signals in one cycle of the row start signal.

20. The display control method according to claim 11, further comprising the steps of: providing a row start signal with a preset frequency; and enabling the timing of the odd-row driving signals and disabling the timing of the even-row driving signals in one cycle of the row start signal.

21. The display control method according to claim 11, further comprising the steps of: outputting a reversal signal and a row start signal, the frequency of the reversal signal being half that of the row start signal.

22. A digital play system, comprising a signal conversion unit for receiving a video signal and converting the video signal into image data; and a liquid crystal display module according to claim 1.
